(19) United States
(12) Patent Application Publication
(10) Pub. No.: US 2011/0037792 A1
(43) Pub. Date: Feb. 17, 2011

(54) METHOD FOR DRIVING PLASMA DISPLAY PANEL AND PLASMA DISPLAY DEVICE

(76) Inventors: Toshikazu Wakabayashi, Osaka (JP); Satoshi Kominami, Osaka (JP); Masumi Izuchi, Osaka (JP); Yasuhiro Arai, Osaka (JP); Junko Matsushita, Osaka (JP); Hiroyasu Makino, Osaka (JP)

Correspondence Address: SNELL & WILMER L.L.P. (Panasonic), 600 ANTON BOULEVARD, SUITE 1400, COSTA MESA, CA, 92626, US

(21) Appl. No.: 12/937,973

(22) PCT Filed: Apr. 10, 2009
(86) PCT No.: PCT/JP2009/001672

§ 371 Date: Oct. 14, 2010

(30) Foreign Application Priority Data
Apr. 28, 2008 (JP) 2008-116719

(51) Int. Cl. G09G 5/10

(52) U.S. Cl. 345/691

(57) ABSTRACT

An object is to provide a method for driving a PDP, which may be a super high-definition panel, and a PDP device capable of assuring the sufficient number of subfields to maintain the image quality and displaying images with the sufficient luminance.

To achieve the above object, one field period is divided into a plurality of subfields each having an address period and a sustain period. A plurality of display electrode pairs are divided in to a plurality N of display electrode pair groups. A start time point of a subfield is set for each display electrode pair group. When a time required for performing one address operation on all the discharge cells of the panel is represented by Tw, the time length of a sustain period of each of the subfields in each of the display electrode pair groups is defined not to exceed Tw×(N−1)/N.

### TECHNICAL FIELD

The present invention relates to a driving method for a plasma display panel and a plasma display device, and in particular to a driving method for a high-definition panel.

### BACKGROUND ART

A plasma display panel (hereinafter, briefly referred to as a “panel”) is a typical AC type surface discharge panel in which a multitude of discharge cells are formed between a front substrate and a back substrate that are disposed facing each other.

On the front substrate, a plurality of display electrode pairs, each of which is composed of a scan electrode and a sustain electrode, are provided in parallel to one another. On the back substrate, a plurality of data electrodes are provided in parallel to one another. The front and the back substrates are arranged such that the display electrode pairs and the data electrodes intersect three-dimensionally, and sealed. A discharge gas fills the internal discharge space formed between the front and the back substrates. The discharge cells are formed where the display electrode pairs oppose the data electrodes.

The following subfield method is used as a panel driving method. One field is divided into a plurality of subfields each having a luminance weight, and grayscale display is achieved by combinations of the subfields that are caused to emit light. Each subfield has an initialization period, an address period and a sustain period. In the initialization period, initialization discharge is generated to form wall charges necessary in the subsequent address operation. In the address period, address discharge is selectively generated in the discharge cells in accordance with an image to be displayed, thereby forming the wall charges. Subsequently, in the sustain period, a sustain pulse is applied alternately to the display electrode pairs each composed of the scan electrode and the sustain electrode so as to generate sustain discharge for only a time period corresponding to the luminance weight. This causes the phosphor layers corresponding to the discharge cells to emit light. Thus, the image is displayed.

As a subfield method, an address display separated scheme (ADS scheme), in which an address period and a sustain (display) period are completely separate from each other in terms of time, is generally used. According to the ADS scheme, since a time period when address discharge is generated in discharge cells and a time period when sustain discharge is generated in the discharge cells do not overlap each other, a panel can be driven in the optimal condition for the address discharge and the sustain discharge during the address period and the sustain period, respectively. Accordingly, discharge control is relatively easy, and the panel can be driven on a more flexible condition.

However, the ADS scheme has the following problem. A sustain period is set at a time period except for an address period. As a result, when an address period is elongated as a panel provides higher-definition images, it is difficult to ensure the sufficient number of subfields necessary for maintaining its image quality with sufficient luminance maintained.

To solve the above problem, Patent Literature 1 discloses the following driving method, for example. Display electrode pairs are divided into a plurality of groups, the address periods of two or more of the plurality of groups do not overlap in terms of time, because each of the groups has a different start time of a subfield.

According to this driving method, the panel can be driven in a sustain period of one group at the same time as an address period of another group. As a result, a driving time for one subfield can be reduced, and correspondingly, the number of the subfields in the one field can be increased.

### [Citation List]

### [Patent Literature]

### [Patent Literature 1]

Japanese Patent Application Publication No. 2005-157338

### SUMMARY OF INVENTION

### Technical Problem

However, as described in Patent Literature 1, a driving time also depends on conditions such as the numbers of groups, scan electrodes, subfields, and sustain pulses, and a time required for address discharge and sustain discharge. Even if each of two or more groups has a different start time of a subfield so that the address periods of the groups do not overlap one another, this does not necessarily assure the sufficient number of subfields provided in one field.

Also, since even higher-definition panels have further been made, a method for driving a super high-definition panel having, for example, 2160 lines or 4320 lines is desired. However, as a panel provides higher-definition images, a time required for address periods is elongated. Thus, it has become difficult to ensure the sufficient number of subfields with the sufficient luminance of the panel being maintained.

The present invention has been made in view of the above problems. It is an object of the present invention to provide a driving method for a panel and a panel device, in which, even when the panel provides super high-definition images, the sufficient number of subfields necessary for assuring the image quality can be provided in one field while sufficient luminance is assured.

### Solution to Problem

In order to solve the above problems, according to the present invention, a plasma display panel having a plurality of data electrodes, a plurality of display electrode pairs each composed of a scan electrode and a sustain electrode, and discharge cells formed at intersections of the display electrode pairs with the data electrodes is driven under conditions where the display electrode pairs are grouped into a plurality of groups, in each group, one field is divided into a plurality of subfields each having an address period, in which address discharge is generated in discharge cells, and a sustain period, in which sustain discharge is generated in the discharge cells, each subfield being provided with a different luminance weight; and the sustain period of each subfield is defined in a range equal to or smaller than Tw×(N−1)/N in accordance with a luminance weight of the subfield, N, which is an integer equal to 2 or greater, representing a number of the groups, and Tw representing a time required for performing one address operation in all the discharge cells.

Here, the above-mentioned “address operation” indicates addressing in a single scan scheme in which a plurality of display electrode pairs in the entire panel are sequentially addressed. According to this single scan scheme, the address periods of the plurality of display electrode pair groups do not overlap each other. That is to say, two or more display electrode pair groups are not addressed at the same time.

The above-mentioned Tw indicates “a time required for performing one address operation in all the discharge cells of the panel in the single scan scheme.”

According to the present invention, the following is favorable. The one field has, at a beginning of, an initialization period, in which an initialization pulse is applied to all the scan electrodes of the plurality of display electrode pairs, and each subfield has, after the sustain period, an erase period, in which erase discharge is generated in the discharge cells where the sustain discharge has been generated in the sustain period.

It is favorable that, in the one field excluding the initialization period and the erase period, an address operation in each group is performed after an address operation in an immediately previous group.

Here, it is favorable that, in the initialization period, an initialization pulse is applied to all the scan electrodes of the plurality of display electrode pairs.

It is favorable that a peak voltage of the initialization pulse applied to the scan electrodes in the initialization period is twice higher than or equal to a sustain voltage applied to the plurality of display electrode pairs in the sustain period.

It is favorable that one of the subfields that is provided with a least luminance weight comes last in the one field.

### Advantageous Effects of Invention

According to the present invention, for each display electrode pair group, a sustain period of a subfield is defined in a range equal to or smaller than Tw×(N−1)/N in accordance with the luminance weight of the subfield. Accordingly, in one field excluding the initialization period and the erase period of each subfield, an address operation in each group can be performed after an address operation in an immediately previous group.

Accordingly, even a super high-definition panel can provide the sufficient number of subfields necessary for assuring the image quality.

N is an integer equal to or greater than 2. Note that the larger N is, the longer a sustain period can be.

Here, an initialization period, in which initialization discharge is generated in the discharge cells, is provided at the beginning of one field. After the sustain period of each subfield in each display electrode pair group, an erase period, in which erase discharge is generated in the discharge cells where discharge has occurred in the sustain period, is provided. As a result, the initialization period contained in one field can be shorter than when each subfield has an initialization period. This contributes to the increase in the number of subfields in one field.

In the initialization period, an initialization pulse is applied to all the scan electrodes of a plurality of display electrode pairs. Accordingly, the peak in the voltage of the initialization pulse can be set to be high.

Suppose that the peak in the voltage of the initialization pulse applied to the scan electrodes is set to be twice higher than or equal to the sustain voltage applied to the plurality of display electrode pairs in the sustain period. Even if an initialization pulse is not applied to all the subfields, if the erase period is provided after the sustain period, each discharge cell can be initialized.

According to the present invention, a subfield, which is one of a plurality of subfields in one field period, having the least luminance weight is arranged at the last of the one field. This can reduce the time length of the last subfield, and this can consequently increases the number of subfields in one field.

In a high-definition panel (1080 lines or more), in particular, in a super high-definition panel having 2160 lines or more, the time period Tw becomes long, and the time period Tw×(N−1)/N becomes also long. Accordingly, on the condition that a time is equal to or shorter than Tw×(N−1)/N, a sustain period of each subfield can be set relatively long. Thus, the present invention is especially effective in a high-definition panel.

### BRIEF DESCRIPTION OF DRAWINGS

FIG. 1 is an exploded perspective view of the structure of a panel used in Embodiment 1;

FIG. 2 is a view showing the arrangement of electrodes of the panel;

FIG. 3 is a time chart showing allocation of address periods and sustain periods for each of N display electrode pair groups;

FIGS. 4A-4D each show a driving method pertaining to Embodiment 1 and a method for setting the number of display electrode pairs;

FIG. 5 shows a waveform of a driving voltage applied to each electrode of the panel pertaining to Embodiment 1;

FIGS. 6A-6B each show a variation of a waveform of a driving voltage applied to each electrode in an erase period pertaining to Embodiment 1;

FIGS. 7A-7B are each a schematic view showing the structure of subfields with regard to a driving voltage waveform pertaining to Embodiment 1;

FIG. 8 is a block diagram of a circuit of a plasma display device pertaining to Embodiment 1;

FIG. 9 is a circuit diagram showing a scan electrode driving circuit of the plasma display device;

FIG. 10 is a circuit diagram showing a sustain electrode driving circuit of the plasma display device;

FIG. 11 is a view showing the arrangement of electrodes of a panel of Embodiment 2; and

FIG. 12 is a schematic view showing the structure of subfields having a driving voltage waveform pertaining to Embodiment 2.

### DESCRIPTION OF EMBODIMENTS

A panel and a method for driving a panel pertaining to embodiments of the present invention are described below with reference to the drawings.

### Embodiment 1

### (Structure of Panel)

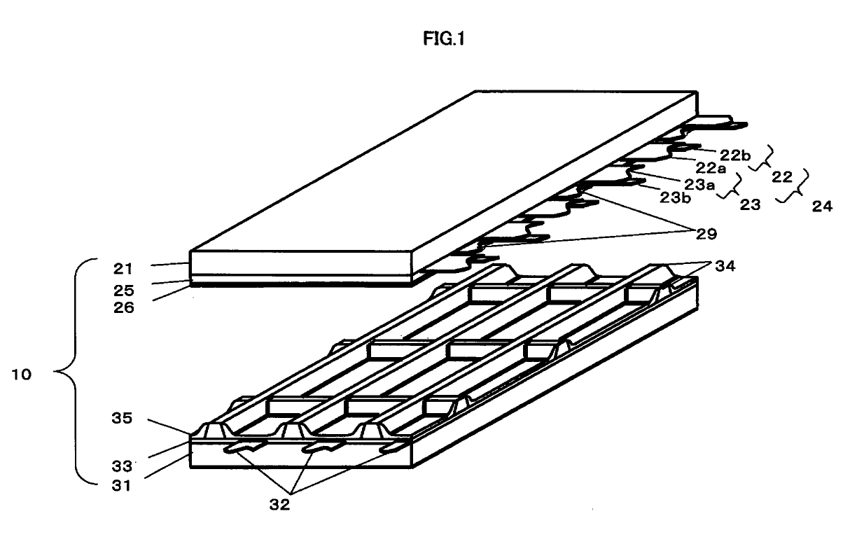

FIG. 1 is an exploded perspective view showing the structure of a panel 10 used in Embodiment 1. On a glass front substrate 21, a plurality of display electrode pairs 24 each composed of a scan electrode 22 and a sustain electrode 23 are provided. Discharge is generated in a discharge gap between the scan electrode 22 and the sustain electrode 23 composing the display electrode pair 24. In order to extract light, the scan electrode 22 has a wide transparent electrode 22a, and the sustain electrode 23 has a wide transparent electrode 23a. Narrow bus electrodes 22b and 23b are layered on the transparent electrodes 22a and 23a, respectively, at a position away from the discharge gap. A black stripe 29 blocking light is provided between the adjacent display electrode pairs 24. A dielectric layer 25 is provided covering the scan electrode 22, the sustain electrode 23 and the black stripe 29. On the dielectric layer 25, a protective layer 26 is provided.

On the back substrate 31, a plurality of data electrodes 32 are provided, and a dielectric layer 33 is provided to cover the data electrodes 32. Furthermore, barrier walls 34 in a grid pattern are provided on the dielectric layer 33. On the lateral surface of each barrier wall 34 and on the dielectric layer 33, a phosphor layer 35 emitting light of red, green, and blue is provided.

The front substrate 21 and the back substrate 31 are opposed to each other with a minute discharge space therebetween such that the display electrode pairs 24 intersect the data electrodes 32. The outer circumferential portion thereof is sealed with a sealing member such as glass frit. A gas mixture of neon and xenon, for example, is enclosed in the discharge space as a discharge gas. The discharge space is divided into a plurality of sections with the barrier walls 34, and discharge cells are formed at the intersection of the display electrode pairs 24 and the data electrodes 32. An image is displayed by discharge and light emission in these discharge cells.

Note that the structure of the panel 10 is not limited to the above, and that the panel 10 may have striped-patterned barrier walls.

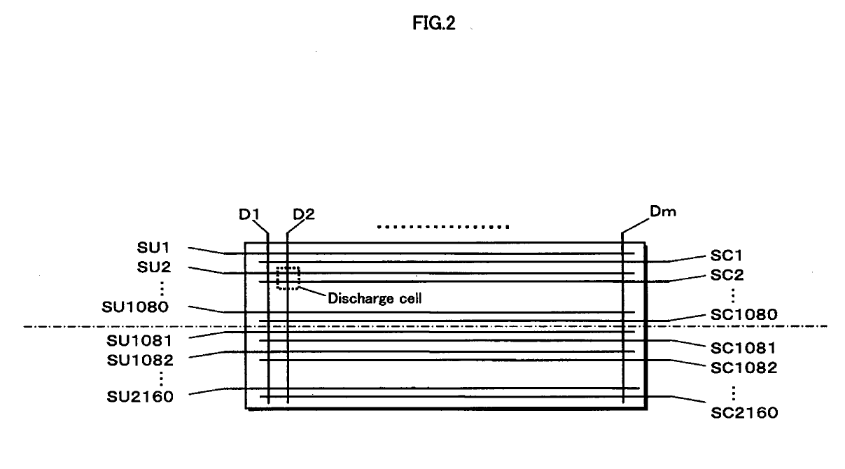

FIG. 2 shows arrangement of the electrodes of the panel 10 used in Embodiment 1. In the panel 10, n scan electrodes SC1-SCn (scan electrode 22 in FIG. 1) and n sustain electrodes SU1-SUn (sustain electrode 23 in FIG. 1) that are long in the row direction (line direction) are arranged, and m data electrodes D1-Dm (data electrodes 32 in FIG. 1) that are long in the column direction are arranged. A discharge cell is formed where a pair of a scan electrode SCi (i=1−n) and a sustain electrode SUi intersect one data electrode Dj (j=1−m). The discharge space has m×n discharge cells formed therein. A description of a method for driving the panel 10 is given on the assumption that n=2160 in this embodiment, although the number of the display electrode pairs is not particularly limited.

The 2160 display electrode pairs composed of n scan electrodes SC1-SC2160 and n sustain electrodes SU1-SU2160 are grouped into a plurality (N) of display electrode pair groups. Each display electrode pair group has (n/N) display electrode pairs. Here, N is a natural number equal to 2 or larger. Points to be considered in its setting are described later.

### (Time Setting of Subfield for Each Group)

The following describes how to set a start time or such of a subfield for each of N display electrode pair groups.

The driving method of Embodiment 1 is similar to the driving method disclosed by Patent Literature 1 in the following. This panel 10 is driven in the single scan scheme in which 2160 lines are addressed one after another. Each of the display electrode pair groups has a different start time of a subfield such that the address periods of two or more of the N display electrode pair groups do not overlap one another. However, they are different in the following. When a time required for performing one address operation in all the discharge cells of the panel is represented as Tw, a sustain period of each subfield is defined for, each display electrode pair group, in a range of Tw×(N−1)/N or smaller in accordance with a luminance weight of the subfield. In other words, they are different in that a sustain period is set such that the inequality Ts<=Tw×(N−1)/N is satisfied. (Here, Ts represents a time allocated for a sustain period of a subfield having the largest luminance weight).

With this setting, the address periods can be allocated for each display electrode pair group such that address operations in the N groups are performed continuously in the entire time of one field except for the initialization period.

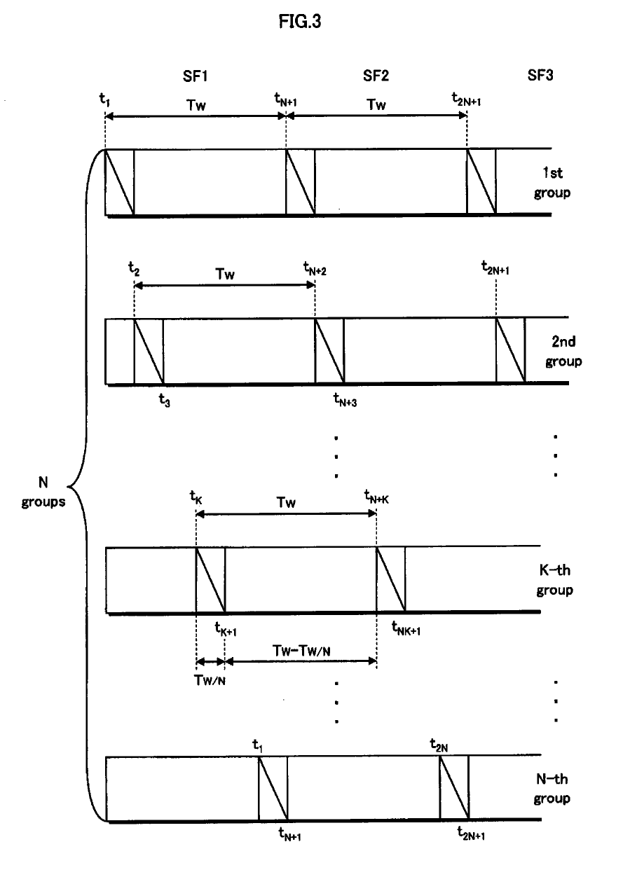

This feature is described with reference to the time chart of FIG. 3.

During a time period between time t1-time t2, SF1 of the first group is addressed. During a time period between time t2-time t3, SF1 of the second group is addressed. During a time period between time tN-time tN+1, SF1 of the N-th group is addressed.

Thus, SF1 of each groups is addressed for a predetermined time period Tw/N (time t1-time tN+1).

Subsequently, during a time period between time tN+1-time tN+2, SF2 of the first group is addressed. During a time period between time tN+2-time tN+3, SF2 of the second group is addressed. During a time period between time t2N-time t2N+1, SF2 of the N-th group is addressed.

Thus, SF2 of each groups is addressed for a predetermined time period Tw/N (time tN+1-time t2N+1).

Similarly, SF3 of each group is addressed for a predetermined time period Tw/N (time t2N+1-time t3N+1).

In general, the K-th subfield SFK of each group is addressed for a predetermined time period Tw/N (time t(K−1)N+1-time tKN+1).

Thus, when address operations are consecutively performed, one address operation takes a time period Tw/N in each group. Since the time length of one subfield is a predetermined time period Tw, the maximum time allocated for a sustain period in one subfield is (Tw−Tw/N)=Tw(1−1/N).

That is to say, if Ts<=Tw×(N−1)/N is satisfied, where N represents the number of display electrode pair groups and where Ts represents a time allocated for a sustain period of a subfield having the largest luminance weight, consecutive address operations can be performed, and the maximum number of subfields can be set in one field period.

Note that when the above inequality is transformed, N>=Tw/(Tw−Ts) holds. This inequality shows that in order to perform consecutive address operations, the display electrode pair groups N should be set to be Tw/(Tw−Ts) or larger.

Note that as N is set to be a larger value, the value of Tw×(N−1)/N increases to approximate Tw. For example, when N=2, the value of Tw×(N−1)/N is ½Tw. When N=3, the value of Tw×(N−1)/N is Tw⅔. When N=4, the value of Tw×(N−1)/N is Tw¾. Thus, the value increases to gradually approximate Tw.

Thus, as N is set to be a larger value, the maximum time Ts allocated for the sustain period can be set to be larger. However, as N increases, the rate of increase of Ts relative to N decreases. Accordingly, it can be assumed that the appropriate value for N is 2-4.

The following describes the specific examples.

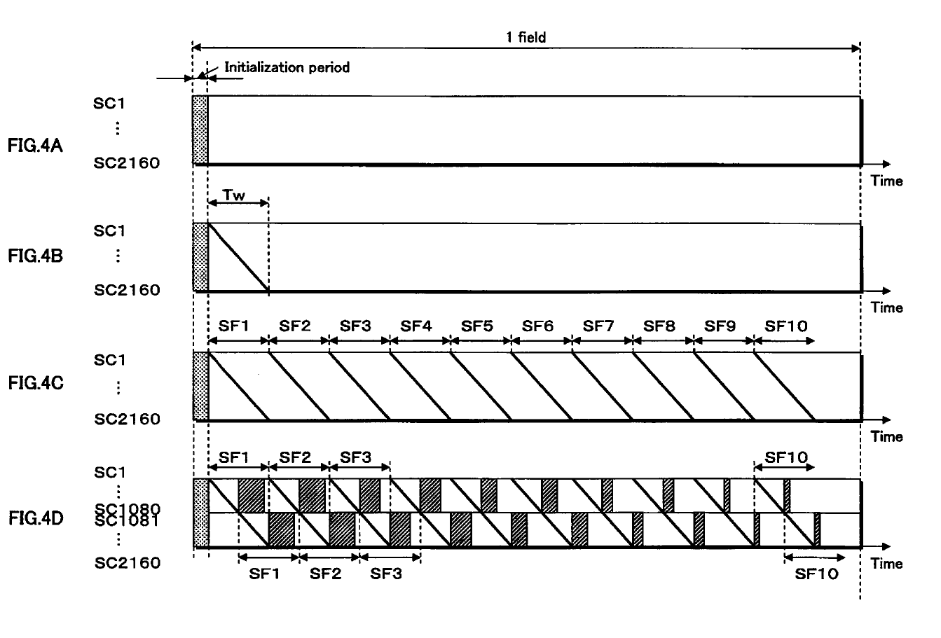

FIGS. 4A-4D each show the driving method for the panel pertaining to Embodiment 1 and a method for setting the number of display electrode pair groups. FIGS. 4A-4D each schematically show the driving voltage waveform during one field period applied to the scan electrodes SC1-SC2160 of the panel 10. In each of FIGS. 4A-4D, in the vertical axis, the scan electrodes SC1-SC2160 are shown, and in the horizontal axis, time is shown. Also, a time when an address operation is performed is represented by the solid line, and a time of a sustain period and an erase period is represented by hatching.

Suppose a time for one field period is 16.7 ms, and a time required for an address operation for one scan electrode is 0.7 μs. Since there are 2160 scan electrodes, a time period Tw necessary for addressing all the scan electrodes is 0.7×2160=1512 μs.

Here, the following assumptions are made. The number of display electrode pair groups N is set to N=2. As shown in FIG. 2, the upper half of the display electrode pairs in the panel belongs to the first display electrode pair group, and the lower half of the display electrode pair in the panel belongs to the second display electrode pair group. That is to say, 1080 scan electrodes SC1-SC1080 and 1080 sustain electrodes SU1-SU1080 belong to the first display electrode pair group, and 1080 scan electrodes SC1081-SC2160 and 1080 sustain electrodes SU1081-SU2160 belong to the second display electrode pair group.

First, as shown in FIG. 4A, an initialization period, in which initialization discharge is concurrently generated in all the discharge cells in the panel, is provided at the beginning of one field period. Here, a time required for an initialization period is assumed to be 500 μs.

Next, as shown in FIG. 4B, the time period Tw required for sequentially applying a scan pulse to the scan electrodes SC1-SC2160 is estimated. Here, it is desirable that a scan pulse is set to be as short as possible and is applied as consecutively as possible such that the scan electrodes SC1-SC2160 are consecutively addressed.

Next, the number of subfields provided in one field is estimated.

Here, since a time required for an erase period is negligible, estimation is made without considering the erase period. A time for the initialization period (0.5 ms) is subtracted from a time for one field period (16.7 ms), and is divided by a time required for performing one address operation on all the scan electrodes (1.5 ms). Thus, a value (16.7−0.5)/1.5=10.8 is obtained. This value corresponds to the number of subfields provided in one field.

Accordingly, as shown in FIG. 4C, ten subfields (SF1, SF2, . . . , SF10) can be assuredly provided in one field at the maximum.

Based on the above observation, as shown in FIG. 2, the display electrode pairs are divided into two display electrode pair groups. As shown in FIG. 4D, a sustain period, in which a sustain pulse is applied, is provided after the address period for addressing the scan electrodes belonging to the respective groups. It is assumed that a sustain pulse of “60,” “44,” “30,” “18,” “11,” “6,” “3,” “2,” “1,” and “1” are applied to the ten subfields.

If a sustain pulse width (period) is assumed to be 10 μs, a time allocated for a sustain period in the subfield “60” having the largest luminance weight is 600 μs.

In this case, since N=2, Tw=1512 μs, and Ts=600 μs, Tw×(N−1)/N=756>=600 holds. Thus, the above inequality Tw×(N−1)/N>=Ts is satisfied.

As described above, the settings such as the number N of display electrode pair groups of the panel 10 and a time for a subfield in each display electrode pair group can be made.

Note that according to the above calculation, an erase period is not considered. However, it is desirable to set that an address operation is not performed if any of the display electrode pair groups is in an erase period. This is because an erase period is not only for erasing wall voltage but also for adjusting the wall voltage of the data electrodes in preparation for the address operation in the subsequent address period, and therefore it is desirable that the voltage of the data electrode is fixed in the erase period.

(Description with Regard to Driving Voltage Waveform)

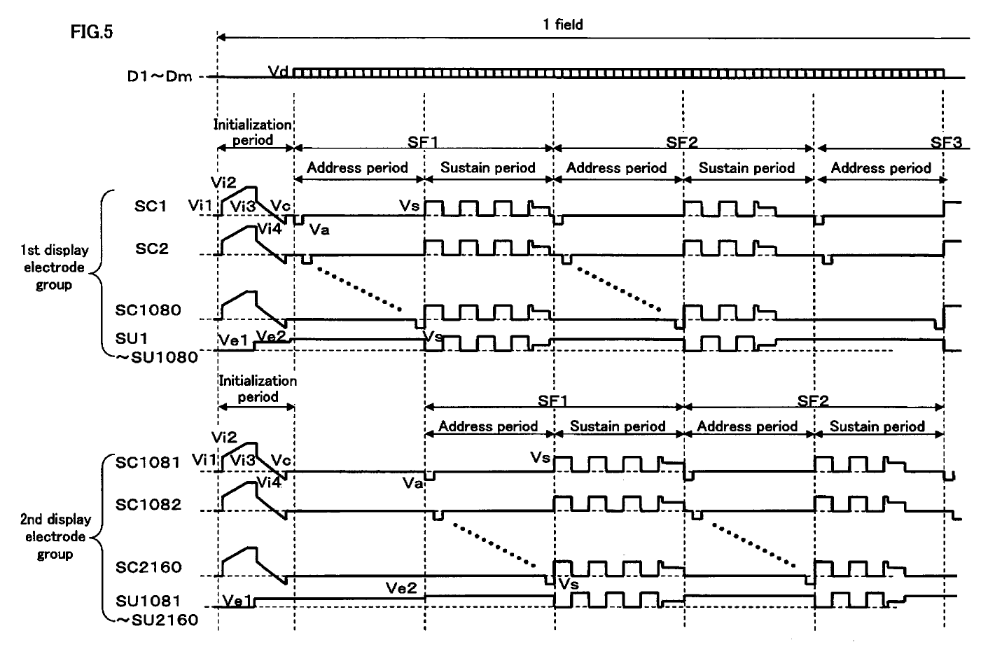

FIG. 5 shows a waveform of a driving voltage applied to each electrode of the panel 10. In this embodiment, an initialization period for concurrently generating initialization discharge in all the discharge cells is provided at the beginning of one field, and an erase period for generating erase discharge in the discharge cells where sustain discharge has been generated in the sustain period is provided after the sustain period of each subfield in each display electrode pair group. FIG. 5 shows an initialization period, address periods of SF1, SF2 and SF3 with regard to the first display electrode pair group, and address periods of SF1 and SF2 with regard to the second display electrode pair group.

First, in the initialization period, 0 (V) is applied to each of the data electrodes D1-Dm and the sustain electrodes SU1-SU2160, and a ramp waveform voltage, which gradually increases from the voltage Vi1 equal to or lower than the starting voltage of the sustain electrodes SU1-SU2160 to the voltage Vi2 greater than the starting voltage, is applied to the scan electrodes SC1-SC2160. Here, it is desirable that the peak in the voltage Vi2 applied to the scan electrodes in the initialization period is set to be twice higher than or equal to the sustain voltage Vs (equal to or greater than 400 V). While the ramp waveform voltage increases, weak initialization discharge is generated between the scan electrodes SC1-SC2160 and the sustain electrodes SU1-SU2160, and between the data electrodes D1-Dm. Subsequently, negative wall voltage is accumulated on the scan electrodes SC1-SC2160, and positive wall voltage is accumulated on the data electrodes D1-Dm and the sustain electrodes SU1-SU2160. Here, the wall voltage accumulated on the electrodes is a voltage generated by the wall charges accumulated on the dielectric layer, the protective layer, and the phosphor layer covering the electrodes.

Subsequently, a positive voltage Ve1 is applied to the sustain electrodes SU1-SU2160, and a ramp waveform voltage that gradually decreases from the voltage Vi3 equal to or lower than the starting voltage of the scan electrodes SC1-SC2160 to the voltage Vi4 that is greater than the starting voltage is applied to the sustain electrodes SU1-SU2160. In the meantime, small initialization discharge is generated between the scan electrodes SC1-SC2160, the sustain electrodes SU1-SU2160, and the data electrodes D1-Dm. Then, the negative wall voltage on the scan electrodes SC1-SC2160 and the positive wall voltage on the sustain electrodes SU1-SU2160 are weakened, and the positive wall voltage on the data electrodes D1-Dm is adjusted to a value appropriate for the address operation. Subsequently, a voltage Vc is applied to the scan electrodes SC1-SC2160.

Thus, the initialization discharge is generated in all the discharge cells, and the initialization is completed.

Next, a description is given of the address period of the SF1 of the first display electrode pair group.

This address operation is performed in the single scan scheme and the 2160 lines are sequentially addressed as follows.

The positive voltage Ve2 is applied to the sustain electrodes SU1-SU2160. A scan pulse having the negative voltage Va is applied to the scan electrode SC1 belonging to the first display electrode pair group, and an address pulse having the positive voltage Vd is applied to the data electrode Dk (k=1−m) corresponding to the discharge cells to emit light. Consequently, a difference in the voltage in the intersection between the data electrode Dk and the scan electrode SC1 is equal to the total of a difference in the externally applied voltage (Vd−Va) and a difference between the wall voltage on the data electrode Dk and the wall voltage on the scan electrode SC1. Thus, the voltage in the intersection between the data electrode Dk and the scan electrode SC1 exceeds the starting voltage. Next, discharge is started between the data electrode Dk and the scan electrode SC1, and then address discharge is generated between the sustain electrode SU1 and the scan electrode SC1. As a result, the positive wall voltages are accumulated on the scan electrode SC1, the negative wall voltages are accumulated on the sustain electrode SU1, and the negative wall voltages are also accumulated on the data electrode Dk. Thus, address discharge is generated in the discharge cells to emit light in the first line and the address operation to accumulate wall voltages on each electrode is performed. On the other hand, since the voltage of the intersection between the data electrodes D1-Dm and the scan electrode SC1, to which an address pulse voltage Vd is not applied, does not exceed the starting voltage, address discharge is not generated.

Subsequently, the scan pulse is applied to the scan electrode SC2 in the second line and an address pulse is applied to the data electrode Dk corresponding to the discharge cells to emit light. As a consequence, address discharge is generated in the discharge cells in the second line to which the scan pulse and the address pulse are concurrently applied, and thus the address operation is performed.

The above-described address operations are repeated till the address operation is performed in the discharge cells in the 1080th line. The address discharge is selectively generated in the discharge cells to emit light so that wall charges are formed in the selected discharge cells.

In this period, the voltage Vc and the voltage Ve are being respectively applied between the scan electrodes SC1081-SC2060 and the sustain electrodes SU1081-SU2060 that belong to the second display electrode pair group. This period is a pause period when no discharge is generated.

Subsequently, a description is given of the address period of the SF1 of the second display electrode pair group.

The positive voltage Ve2 is applied to the sustain electrodes SU1-SU2160. A scan pulse is applied to the scan electrode SC1081 belonging to the second display electrode pair group, and an address pulse is applied to the data electrode Dk (k=1−m) corresponding to the discharge cells to emit light. As a result, address discharge is generated between the data electrode Dk and the scan electrode SC1081 and between the sustain electrode SU1081 and the scan electrode SC1081. Subsequently, a scan pulse is applied to the scan electrode SC1082, and an address pulse is applied to the data electrode Dk corresponding to the discharge cells to emit light. As a consequence, address discharge is generated in the discharge cells in the 1082nd line to which the scan pulse voltage Va and the address pulse voltage Vd are concurrently applied.

The above-described address operations are repeated till the address operation is performed in the discharge cells in the 2160th line, and address discharge is selectively generated in the discharge cells to emit light so that wall charges are formed in the selected discharge cells.

The above address period of the second display electrode pair group corresponds to the sustain period in the SF1 in the first display electrode pair group. That is to say, the sustain pulse of “60” is alternately applied to the scan electrodes SC1-SC1080 and the sustain electrodes SU1-SU1080 belonging to the first display electrode pair group, which causes the discharge cells in which address discharge is generated to emit light.

More specifically, first, a sustain pulse having a positive voltage Vs is applied to the scan electrodes SC1-SC1080, and 0 (V) is applied to the sustain electrodes SU1-SU1080. As a consequence, a difference in the voltage between the scan electrode SCi and the sustain electrode SUi in the discharge cells where the address discharge is generated is the total of the sustain pulse voltage Vs and a difference of the wall voltage on the scan electrode SCi and the wall voltage on the sustain electrode SUi. Thus, the voltage between the scan electrode SCi and the sustain electrode SUi in the discharge cells exceeds the starting voltage. Then, sustain discharge is generated between the scan electrode SCi and the sustain electrode SUi. The ultraviolet rays generated by the sustain discharge cause the phosphor layer 35 to emit light. As a result, negative wall voltages are accumulated on the scan electrode SCi, and positive wall voltages are accumulated on the sustain electrode SUi. Sustain discharge is not generated in the discharge cells in which address discharge is not generated in the address period, and the wall voltage at the completion of the initialization period is maintained.

Subsequently, 0 (V) and a sustain pulse are respectively applied to the scan electrodes SC1-SC1080 and the sustain electrodes SU1-SU1080. As a result, in the discharge cells where sustain discharge is generated, a difference in voltage between the sustain electrode SUi and the scan electrode SCi exceeds the starting voltage. The sustain discharge is generated again between the sustain electrode SUi and the scan electrode SCi, negative wall voltages are accumulated on the sustain electrode SUi, and positive wall voltages are accumulated on the scan electrode SCi. After this, similarly, the sustain pulse is alternately applied between the scan electrodes SC1-SC1080 and between the sustain electrodes SU1-SU1080, thereby giving a potential difference between the electrodes of the display electrode pair. Thus, in the discharge cells in which address discharge is generated in the address period, sustain discharge is continually generated, thereby causing the discharge cells to emit light.

An erase period is provided after the sustain period. In the erase period, a so-called narrow pulse voltage difference is applied between the scan electrodes SC1-SCn and the sustain electrodes SU1-SUn, so that wall voltages on the scan electrode SCi and the sustain electrode SUi are erased with the positive wall voltage remaining on the data electrode Dk.

Subsequently, a description is given of the address period in SF2 of the first display electrode pair group.

A positive voltage Ve2 is applied to the sustain electrodes SU1-SU2160. Similarly to the address period in SF1, a scan pulse is sequentially applied to the scan electrodes SC1-SC1080 that belong to the first display electrode pair group, and an address pulse is applied to the data electrode Dk. Thus, the address operation is performed in the discharge cells in the 1-1080th lines.

This address period in SF2 corresponds to the sustain period of SF1 of the second display electrode pair group. That is to say, a sustain pulse of “60” is alternately applied to the scan electrodes SC1081-SC2160 and the sustain electrodes SU1081-SU2160 belonging to the second display electrode pair group, thereby causing the discharge cells where the address discharge is performed to emit light.

In the erase period, which is provided after the sustain period, a so-called narrow pulse voltage difference is applied between the scan electrodes SC1081-SC2160 and the sustain electrodes SU1081-SU2160, so that wall voltages on the scan electrode SCi and the sustain electrode SUi are erased while the positive wall voltage remains on the data electrode Dk.

After the erase period, the address period in SF2 of the second display electrode pair group, the address period in SF3 of the first display electrode pair group, . . . , and the address period in SF10 of the second display electrode pair group follow. Then, the sustain period and the erase period in SF10 of the second display electrode pair group follow. Thus, one field is completed.

### (Effect by Driving Method of Embodiment)

As described above, according to the driving method of this embodiment, for each display electrode pair group, a sustain period in each of the subfields is defined in a range equal to or lower than Tw×(N−1)/N in accordance with a luminance weight of the subfield. Accordingly, a scan pulse and an address pulse can be provided such that after the initialization period address operations can be performed one after another in any of the display electrode pair groups. As a result, one field period can be defined to have ten subfields, which is the maximum number of subfields that can be defined in one field period.

According to a panel having a small number of lines, since the time period Tw necessary for operating one address operation in all the scan electrodes is short, a sustain period, which can be set in a range equal to or smaller than Tw×(N−1)/N, in each subfield is shortened. However, according to a high-definition panel having 1080 lines or more, the time period Tw necessary for operating one address operation in all the scan electrodes is long, and the time of Tw×(N−1)/N is also long. As a result, the maximum time Ts of the sustain period that can be allocated for each subfield becomes also long. Accordingly, the driving method in accordance with this embodiment is especially useful for driving a high-definition panel.

According to the driving method of this embodiment, one field has, at the beginning thereof, an initialization period when initialization discharge is concurrently generated in all the discharge cells, and each subfield does not have an initialization period. Accordingly, compared with a case where each subfield has an initialization period, a time of an initialization period in one field can be significantly reduced. This contributes to increase the number of subfields provided in one field.

Note that if an all-cell initialization pulse having a high voltage (twice higher than or equal to Vs of the sustain voltage) as mentioned above, which is particularly the all-cell initialization pulse with a ramp waveform as shown in FIG. 5, is applied at the beginning of one field, the wall charges in each discharge cell can be sufficiently controlled with application of an erase pulse to each subfield without application of an initialization pulse.

According to this embodiment, one field is completed with a sustain period and an erase period of the second display electrode pair group. Accordingly, as shown by the example in FIG. 4, when a subfield having the least luminance weight is provided in the end of the one field, a driving time of the subfield can be reduced.

Thus, reduction of a driving time of the last subfield contributes to increase the number of subfields provided in one field.

Note that, according to the above description, the erase period is supposed to be for performing an erase operation by application of a narrow pulse voltage difference between the scan electrode and the sustain electrode, and that an address operation is supposed to be performed when any display electrode pair groups are in an erase period. The structure of subfields and the number of display electrode pair groups are defined without considering a time required for an erase period. However, since a certain amount of time is necessary for an erase operation, as described above, when any of the display electrode pair groups is in an erase period, it is desirable to define that an address operation is not operated in the erase period.

(Variation with Regard to Erase Period)

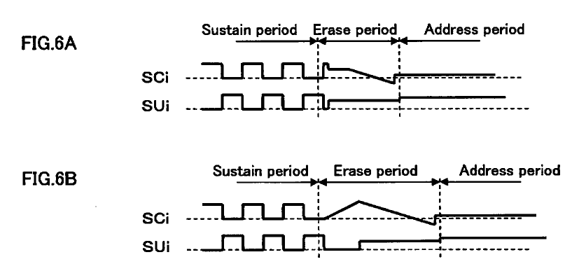

FIGS. 6A and 6B each show a variation of a driving voltage waveform applied to each electrode during an erase period. According to the driving voltage waveform shown in FIG. 6A, after a narrow pulse voltage difference is applied between the scan electrode SCi and the sustain electrode SUi in the erase period, a gradually falling ramp waveform voltage is applied to the scan electrode SCi. According to this driving waveform, although a time required for the erase period is increased, a wall voltage on each electrode can be controlled with accuracy.

Also, according to a driving voltage waveform shown in FIG. 6B, after a gradually rising ramp waveform voltage is applied to the scan electrode SCi in the erase period, a gradually falling ramp waveform voltage is applied to the scan electrode SCi. According to this driving waveform, although an amount of time for the erase period is increased, the wall voltage on each electrode can be controlled with accuracy.

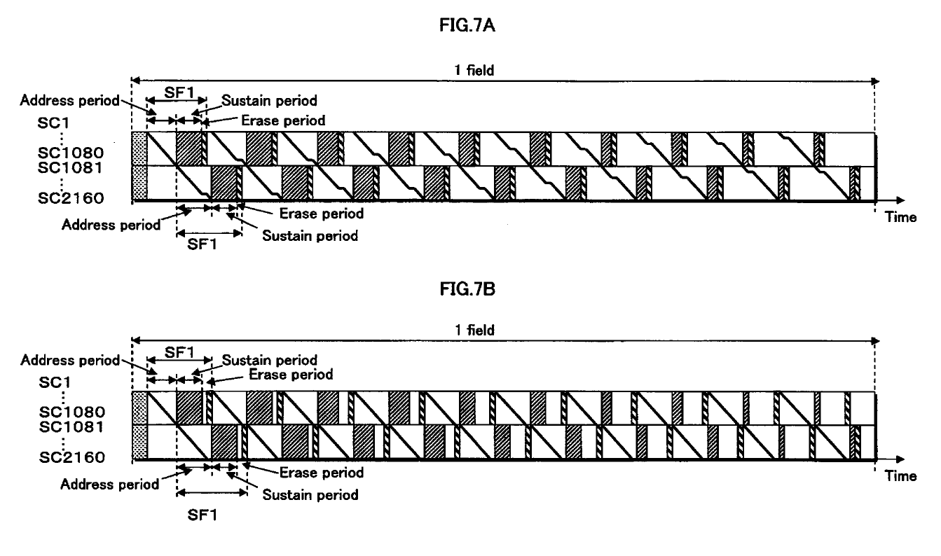

FIG. 7 is a schematic view showing the structure of subfields with regard to the driving voltage waveform. In the vertical axis, the scan electrodes SC1-SC2160 are shown, and in the horizontal axis, time is shown. Also, a time when an address operation is performed is represented by the solid line, and a time of a sustain period and an erase period is represented by hatching. FIG. 7A shows a driving voltage waveform where an erase period is provided immediately after a sustain period. When the first display electrode pair group is in an erase period, an address operation is not performed in the second display electrode pair group. When the second display electrode pair group is in an erase period, an address operation is not performed in the first display electrode pair group. FIG. 7B shows a driving voltage waveform where an erase period for the previous subfield is provided immediately before the address period. When it is an erase period in the first display electrode pair group, an address operation is not performed in the second display electrode pair group. When the second display electrode pair group is in an erase period, an address operation is not performed in the first display electrode pair group.

Thus, in a case where an address operation is not performed when any of the display electrode pair groups is in an erase period, the subfield structure and the group number N of display electrode pairs should be defined in consideration of a time required for the erase period.

### (Circuit Structure of Plasma Display Device 100)

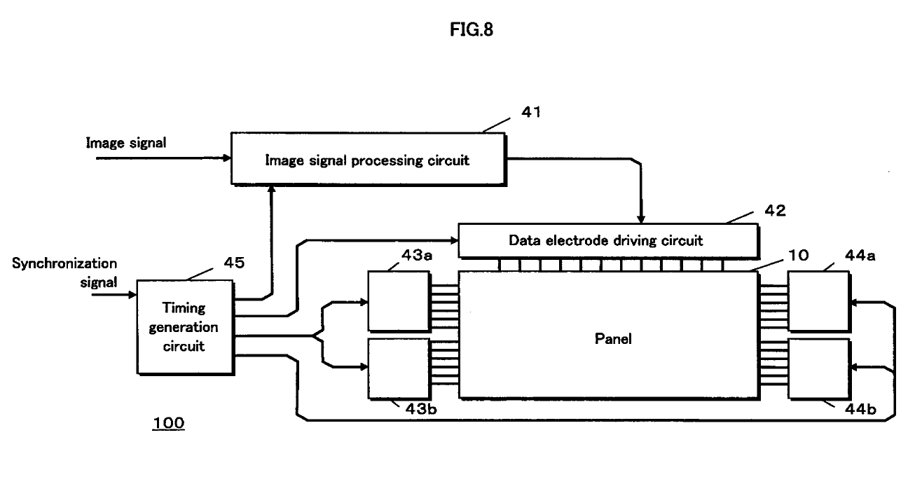

FIG. 8 is a circuit block diagram of a plasma display device 100.

The plasma display device 100 includes a panel 10, an image signal processing circuit 41, a data electrode driving circuit 42, scan electrode driving circuits 43a and 43b, sustain electrode driving circuits 44a and 44b, a timing generation circuit 45 and a power supply circuit (unillustrated) that supplies necessary power to each circuit block.

The image signal processing circuit 41 converts an image signal to image data showing whether each subfield emits light or not. The data electrode driving circuit 42 includes m switches for applying an address pulse voltage Vd or 0 (V) to each of m data electrodes D1-Dm. The data electrode driving circuit 42 converts image data outputted from the image signal processing circuit 41 into an address pulse corresponding to each of the data electrodes D1-Dm, and applies the address pulse to each of the data electrodes D1-Dm.

The timing generation circuit 45 generates various types of timing signals for controlling the operations of the circuits based on a horizontal synchronization signal and a vertical synchronization signal, and supplies the timing signals to the respective circuits.

The timing generation circuit 45 generates a field starting signal based on the vertical synchronization signal V when a predetermined time has passed. The timing generation circuit 45 generates a timing signal that instructs the start of each of the initialization period, the address period, and the sustain period of each subfield by using this field starting signal as the start point of the field. Furthermore, the timing generation circuit 45 generates a timing signal that instructs each of the driving circuits 42, 43a, 43b, 44a, and 44b when to generate a pulse by counting a clock using the timing signal as the start point, and outputs the timing signal to each driving circuit.

The scan electrode driving circuit 43a drives the scan electrodes SC1-SC1080 based on the timing signals. The scan electrode driving circuit 43b drives the scan electrodes SC1081-SC2160 based on the timing signals. The sustain electrode driving circuit 44a drives the sustain electrodes SU1-SU1080 based on the timing signals. The sustain electrode driving circuit 44b drives the sustain electrodes SU1081-SU2160 based on the timing signals.

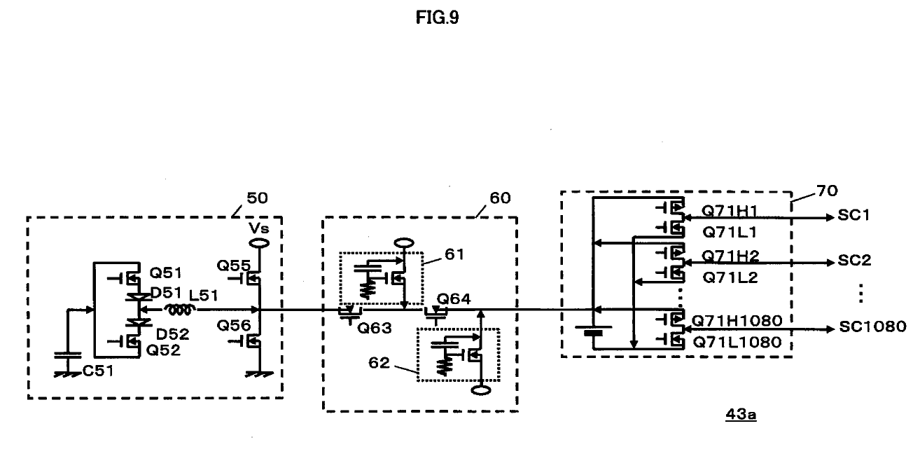

FIG. 9 is a circuit diagram of the scan electrode driving circuit 43a included in the plasma display device 100. The scan electrode driving circuit 43a includes a sustain pulse generation circuit 50, an initialization waveform generation circuit 60, and a scan pulse generation circuit 70.

The sustain pulse generation circuit 50 includes a capacitor C51 that is a power collector for collecting the power, switching elements Q51 and Q52, backflow preventer diodes D51 and D52, a resonance inductor L51, and switching elements Q55 and Q56 that composes a voltage clamp part. The sustain pulse generation circuit 50 applies a sustain pulse to the scan electrodes SC1-SC1080.

The power collector rises and falls a sustain pulse by causing LC resonance between the interelectrode capacity between the display electrodes and the inductor L51. When the sustain pulse is risen, charges accumulated in the capacitor C51 for collecting power is transferred to the interelectrode capacity via the switching element Q51, the diode D51 and the inductor L51. When the sustain pulse is fallen, the charges accumulated in the interelectrode capacity is transferred to the capacitor C51 for collecting power via the inductor L51, the diode D52 and the switching element Q52. Thus, since the power collector drives the display electrodes with the use of the LC resonance, the power collector can drive the display electrodes with power consumption 0, ideally substantially without power supplied from the power supply.

Note that the capacitor C51 for collecting power has a sufficiently large capacity compared with the interelectrode capacity, and is charged at approximately Vs/2, which is half of the voltage Vs, to work as the power supply of the power collector.

The voltage clamp part clamps at the voltage Vs by connecting the display electrodes to the power supply via the switching element Q55, or clamps at the voltage 0 (V) by connecting the display electrodes to the ground via the switching element Q56. Accordingly, the impedance of the voltage clamp part when it applies a voltage is small, so that a large discharge current caused by strong sustain discharge can be stably applied.

Thus, the sustain pulse generation circuit 50 applies a sustain pulse to the scan electrodes SC1-SC1080 by controlling the switching elements Q51, Q52, Q55, and Q56. Note that these switching elements can be realized by using a generally known element such as a MOSFET and an IGBT.

The initialization waveform generation circuit 60 includes a Miller integrator circuit 61 for applying a gradually rising ramp waveform voltage to the scan electrodes SC1-SC1080 in the initialization period, and a Miller integrator circuit 62 for applying a gradually falling ramp waveform voltage to the scan electrodes SC1-SC1080 in the initialization period. Here, the switching elements Q63 and Q64 are each a separation switch and is provided to prevent the backflow of the current via a parasitic diode of the switching element including the sustain pulse generation circuit 50 and the initialization waveform generation circuit 60.

With such an initialization waveform generation circuit 60, an initialization pulse that is equal to the maximum voltage of 400V or greater can be concurrently applied to the scan electrodes SC1-SC1080.

The scan pulse generation circuit 70 includes switching elements Q71H1 and Q71L1 for applying the scan voltage Va to the scan electrode SC1 as necessary, switching elements Q71H2 and Q71L2 for the application to the electrode SC2, . . . , and switching elements Q71H1080 and Q71L1080 for the application to the scan electrode SC1080. At the time as described above, the scan voltage Va is applied to the scan electrodes SC1-SC1080 one after another.

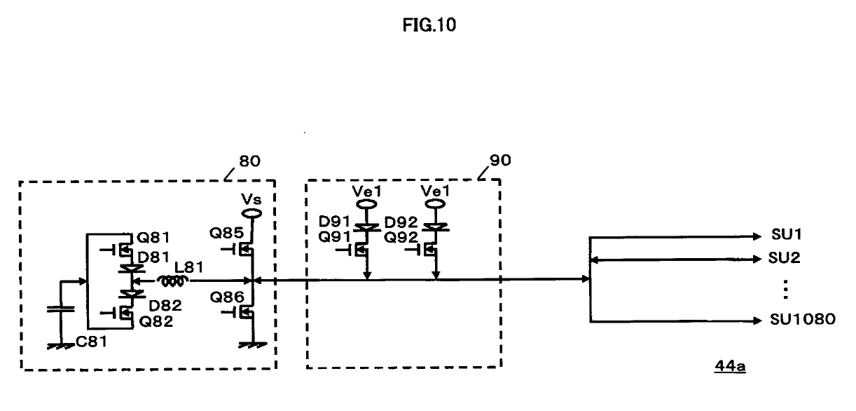

FIG. 10 is a circuit diagram of a sustain electrode driving circuit 44a included in the plasma display device 100. The sustain electrode driving circuit 44a includes a sustain pulse generation circuit 80 and a constant voltage generation circuit 90.

The sustain pulse generation circuit 80 has substantially the same structure as the sustain pulse generation circuit 50. The sustain pulse generation circuit 80 includes a capacitor C81 that is a power collector for collecting power, and switching elements Q81 and Q82, backflow preventer diodes D81 and D82, a resonance inductor L81, and switching elements Q85 and Q86 that compose a voltage clamp part. The sustain pulse generation circuit 80 applies a sustain pulse to the sustain electrodes SU1-SU1080.

The constant voltage generation circuit 90 includes a switching element Q91 and a backflow preventer diode D91. In an initialization period, the constant voltage generation circuit 90 applies the positive voltage Ve1 to the sustain electrodes SU1-SU1080. The constant voltage generation circuit 90 further includes a switching element Q92 and a backflow preventer diode D92. In an address period, the constant voltage generation circuit 90 applies a positive voltage Ve1 to the sustain electrodes SU1-SU1080.

Note that descriptions of the scan electrode driving circuit 43b and the sustain electrode driving circuit 44b are omitted, because the scan electrode driving circuit 43b has substantially the same structure as the scan electrode driving circuit 43a and the sustain electrode driving circuit 44b has substantially the same structure as the sustain electrode driving circuit 44a.

### Embodiment 2

In the above-described specific example in accordance with Embodiment 1, the description is given of a case where the number N of the display electrode pair groups is two. In this embodiment, a description is given of a case where the number N of the display electrode pair groups is defined as a larger value than two.

This embodiment is similar to Embodiment 1 as follows. The address operation is performed in the single scan scheme, and a time for one field period is assumed to be 16.7 ms. A time required for an initialization period is assumed to be 500 μs, and a time required for an address operation on one scan electrode is assumed to be 0.7 μs. A time period Tw required for performing an address operation in all the scan electrodes is assumed to be 1512 μs. Ten subfields can be provided for one field because the continuous address operations can be performed, which is also similar to Embodiment 1.

However, in this embodiment, a sustain pulse to be applied to the subfields is assumed to be “110,” “81,” “55,” “33,” “20,” “11,” “6,” “4,” “2,” and “1.” When a period of a sustain pulse is assumed to be 10 μs, the maximum time Ts of the sustain period for supplying a sustain pulse is 10×110=1100 μs.

Suppose that N is determined to satisfy the expression N>=Tw/(Tw−Ts) based on the time period Tw necessary for performing one address operation on all the scan electrodes and the maximum time Ts allocated for a sustain period when a sustain pulse is applied. Since Tw/(Tw−Ts)=1512/(1512−1100)=3.67, if the number of display electrode pair groups N is defined as four or greater, N>=Tw/(Tw−Ts) is satisfied (Ts<=Tw×(N−1)/N is also satisfied).

Accordingly, the number of display electrode pair groups N is defined as four in this embodiment.

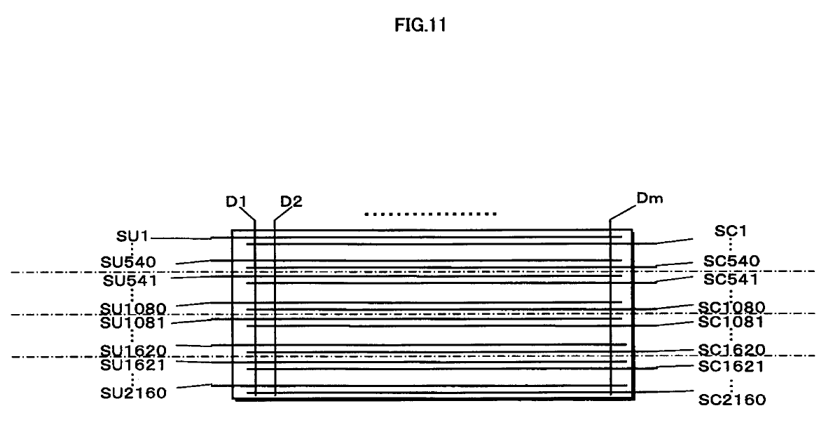

FIG. 11 is a view showing the arrangement of electrodes in a panel 10 in accordance with Embodiment 2.

The panel is divided into four display electrode pair groups with reference to the vertical direction. The display electrode pairs are divided into the first display electrode pair group, the second display electrode pair group, the third display electrode pair group, and the fourth display electrode pair group in the descending order from the upper portion of the panel. More specifically, the scan electrodes SC1-SC540 and the sustain electrodes SU1-SU540 belong to the first display electrode pair group. The scan electrodes SC541-SC1080 and the sustain electrodes SU541-SU1080 belong to the second display electrode pair group. The scan electrodes SC1081-SC1620 and the sustain electrodes SU1081-SU1620 belong to the third display electrode pair group. The scan electrodes SC1621-SC2160 and the sustain electrodes SU1621-SU2160 belong to the fourth display electrode pair group.

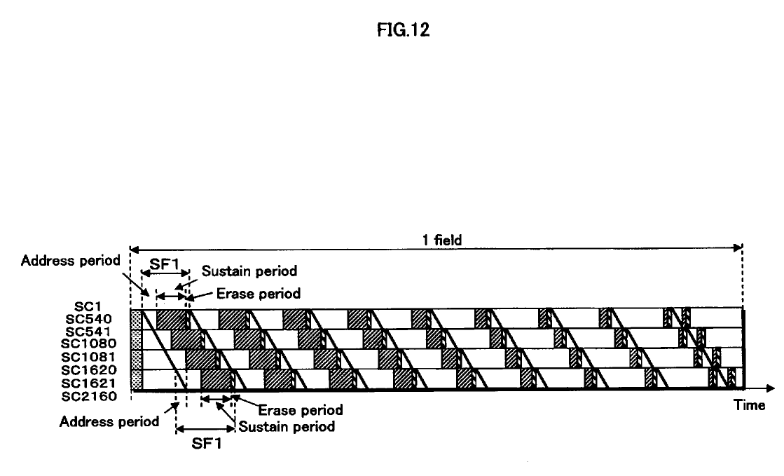

FIG. 12 is a schematic view showing the structure of subfields with regard to a driving voltage waveform pertaining to Embodiment 2. In the vertical axis, the scan electrodes SC1-SC2160 are shown, and in the horizontal axis, time is shown. Also, a time when an address operation is performed is represented by the solid line, and a time of a sustain period and an erase period is represented by hatching.

Compared with Embodiment 1, the number N of the display electrode pair groups is increased so that the value of Tw×(N−1)/N is larger. Thus, the time Ts that can be allocated for a sustain period is elongated, correspondingly.

Accordingly, the number of sustain pulses applied to the display electrode pairs during the sustain period can be increased. This enhances the luminance of the light emission of the panel.

In this embodiment, an erase period is provided immediately before the address period in the subsequent subfield. The panel is driven such that address operations in the display electrode pair groups are performed continuously in the one field period excluding the initialization period and the erase period. In addition, a period when discharge does not occur is provided between the address period and the sustain period such that the sustain period is completed immediately before the erase period. Thus, with the erase period provided immediately after the sustain period, erase discharge can be generated with the use of the remainder of the sustain discharge. Accordingly, stable erase operation can be performed.

### (Modification, etc.)

Note that the specific values described in Embodiments 1 and 2 are merely examples. The values may be set to be optimal values as necessary in accordance with the features of a panel and the specifications of a plasma display device.

Also, in Embodiments 1 and 2, a description is given of an example where the panel is driven in the single scan scheme in which the 2160 lines are sequentially addressed. However, for example, in a panel with 4320 lines driven in a publicly-known dual drive scheme, the driving method described in the above embodiment can be applied to the divided two areas. With this, a super high-definition PDP with 4320 lines can be realized. In such a case, although a driver is required for each area, a super high-definition PDP can be realized with relative ease.

### INDUSTRIAL APPLICABILITY

According to the present invention, a super high-definition panel with 2160 lines or more can be driven in the single scan scheme with sufficient luminance, having the sufficient number of subfields provided for assuring the image quality. Thus, the present invention is effective for driving a high-definition plasma display device with high luminance.

### REFERENCE SIGNS LIST

10 panel
22 scan electrode
23 sustain electrode
24 display electrode pair
32 data electrode
41 image signal processing circuit
42 data electrode driving circuit
43a, 43b scan electrode driving circuit
44a, 44b a sustain electrode driving circuit
43 display electrode pair driving circuit
45 timing generation circuit
100 plasma display device

1. A method for driving a plasma display panel having a plurality of data electrode pairs each composed of a scan electrode and a sustain electrode, a plurality of data electrodes, and discharge cells formed at intersections of the display electrode pairs with the data electrodes, wherein
the plasma display panel is driven under conditions where,
the display electrode pairs are grouped into a plurality of groups,
in each group, one field is divided into a plurality of subfields each having an address period, in which address discharge is generated in discharge cells, and a sustain period, in which sustain discharge is generated in the discharge cells, each subfield being provided with a different luminance weight, and
a length of the sustain period of each subfield is defined in a range equal to or smaller than Tw×(N−1)/N in accordance with a luminance weight of the subfield,
N, which is an integer equal to 2 or greater, representing a number of the groups, and
Tw representing a time required for performing one address operation in all the discharge cells in the panel,
the one field has, at a beginning thereof, an initialization period, in which an initialization pulse is applied to all the scan electrodes of the plurality of display electrode pairs, and
each subfield has, after the sustain period, an erase period, in which erase discharge is generated in the discharge cells where the sustain discharge has been generated in the sustain period, the erase discharge being caused by application of a voltage having a rising waveform part and a subsequent falling waveform part to all the scan electrodes.

2. The method for driving the plasma display panel of claim 1, wherein
the sustain period of each subfield is defined in a range equal to or smaller than {Tw×(N−1)/N}−(Te−Tea) in accordance with a luminance weight of the subfield,
when one or more groups are in the erase period, an address operation is performed in any of the groups during a time period Tea in the erase period, and no address operation is performed in any lines of remainder of the groups after the time period Tea, and
the time period Tea represents a time period from start of the erase period to a time point when a potential applied to the scan electrodes reaches a predetermined potential Vea=VSUS/2+Vda+Veset−Vfd−Vfs,
Veset representing a highest potential of a rising waveform applied to the scan electrodes in the erase period,
Vfs representing a discharge starting voltage applied between the scan electrodes and the sustain electrodes,
Vfd representing a discharge starting voltage applied between the scan electrodes and the data electrodes,
Vda representing a voltage applied to the data electrodes in the address period, and
VSUS representing a sustain voltage applied to the display electrode pairs in the sustain period.

3. (canceled)

4. The method for driving the plasma display panel of claim 1, wherein
a peak voltage of the initialization pulse applied to the scan electrodes in the initialization period is twice higher than or equal to a sustain voltage applied to the plurality of display electrode pairs in the sustain period.

5. The method for driving the plasma display panel of claim 1, wherein
in the one field excluding the initialization period and the erase period, an address operation in each group is performed after an address operation in an immediately previous group.

6. The method for driving the plasma display panel of claim 1, wherein
one of the subfields that is provided with a least luminance weight comes last in the one field.

7. A plasma display device that includes (i) a plasma display panel having a plurality of data electrodes, a plurality of display electrode pairs each composed of a scan electrode and a sustain electrode, and discharge cells being formed at intersections of the display electrode pairs with the data electrodes, and (ii) a driving circuit for driving the plasma display panel, wherein
the driving circuit groups the display electrode pairs into a plurality of groups,
the driving circuit divides, in each group, one field into a plurality of subfields each having an address period, in which address discharge is generated in discharge cells, and a sustain period, in which sustain discharge is generated in the discharge cells, each subfield being provided with a different luminance weight, and
the driving circuit defines the sustain period of each subfield in a range equal to or smaller than Tw×(N−1)/N in accordance with a luminance weight of the subfield,
N, which is an integer equal to 2 or greater, representing a number of the groups, and
Tw representing a time required for performing one address operation in all the discharge cells in the panel,
the one field has, at a beginning thereof, an initialization period, in which an initialization pulse is applied to all the scan electrodes of the plurality of display electrode pairs, and
each subfield has, after the sustain period, an erase period in which erase discharge is generated in the discharge cells where the sustain discharge has been generated in the sustain period, the erase discharge being caused by application of a voltage having a rising waveform part and a subsequent falling waveform part to all the scan electrodes.

8. The plasma display device of claim 7, wherein
the sustain period of each subfield is defined in a range equal to or smaller than {Tw×(N−1)/N}−(Te−Tea) in accordance with a luminance weight of the subfield,
when one or more groups are in the erase period, an address operation is performed in any of the groups during a time period Tea in the erase period, and no address operation is performed in any lines of remainder of the groups after the time period Tea, and
the time period Tea represents a time period from start of the erase period to a time point when a potential applied to the scan electrodes reaches a predetermined potential Vea=VSUS/2+Vda+Veset−Vfd−Vfs,
Veset representing a highest potential of a rising waveform applied to the scan electrodes in the erase period,
Vfs representing a discharge starting voltage applied between the scan electrodes and the sustain electrodes,
Vfd representing a discharge starting voltage applied between the scan electrodes and the data electrodes,
Vda representing a voltage applied to the data electrodes in the address period, and
VSUS representing a sustain voltage applied to the display electrode pairs in the sustain period.

9. (canceled)

10. The plasma display device of claim 7, wherein
a peak voltage of the initialization pulse applied to the scan electrodes in the initialization period is twice higher than or equal to a sustain voltage applied to the plurality of display electrode pairs in the sustain period.

11. The plasma display device of claim 7, wherein
in the one field excluding the initialization period and the erase period, an address operation in each group is performed after an address operation in an immediately previous group.

12. The plasma display device of claim 7, wherein
one of the subfields that is provided with a least luminance weight comes last in the one field.
